(19) United States
(12) Patent Application Publication
(10) Pub. No.: US 2007/0236278 A1
(43) Pub. Date: Oct. 11, 2007

(54) Internal voltage generator for semiconductor integrated circuit capable of compensating for change in voltage level

(75) Inventors: Se Kyung Hur, Gyeonggi-do (KR); Jong Won Lee, Gyeonggi-do (KR)

Correspondence Address: VENABLE LLP, P.O. BOX 34385, WASHINGTON, DC, 20043-9998, US

(73) Assignee: Hynix Semiconductor Inc., Gyeonggi-do (KR)

(21) Appl. No.: 11/647,378

(22) Filed: Dec. 29, 2006

(30) Foreign Application Priority Data
Apr. 6, 2006 (KR) 10-2006-0031635

(51) Int. Cl. G05F 1/10

(52) U.S. Cl. 327/536

(57) ABSTRACT

The internal voltage generator includes a level detector for comparing an internal voltage with a reference voltage to output a level detecting signal; a pump controller for outputting a pump enable signal in response to a mode signal and the level detecting signal; and a voltage pump for generating the internal voltage in response to the pump enable signal.

### FIELD OF THE INVENTION

1. Technical Field

The present invention relates to an internal voltage generator for a semiconductor integrated circuit, and more particularly, to an internal voltage generator for a semiconductor memory integrated circuit which is capable of compensating for a change in voltage level using a period of a pump enable signal.

2. Related Art

The development of information processing technology has led to a sudden increase of simultaneously processed information and highly-integrated semiconductor integrated circuits. This results in increased power consumption. To reduce power consumption, it is suggested that semiconductor apparatuses are driven at a low voltage. Applications for low voltage driving are being developed.

The conventional semiconductor integrated circuits need voltages for performing specific operations. Such voltages are called internal voltages. The internal voltages are generated by an internal voltage generator. The internal voltages may include a VBB and a VPP.

The VBB is provided to improve a charge sharing characteristic and a refresh characteristic. VBB is a voltage applied to a well region in a peripheral region.

If VBB having a voltage value lower than the ground voltage is applied to the well region, the junction capacitance between a bit line and a junction region connected to the bit line is reduced, to improve the charge sharing characteristic and the refresh characteristic.

The VBB level significantly affects an operational characteristic of NMOS transistors in a core region. However as an integration density of the semiconductor integrated circuit increases, a number of memory cells operated simultaneously is increased. Further, when data is stored in and/or read from the cells, a large amount of charges flow from a depletion region within an n-type junction region in the well region to which VBB is being applied and from a depletion region between the well region and a nearby well region, to the well region applied with VBB. As a result, the negative VBB level gradually increases. Accordingly, a circuit for returning VBB to a desired level is provided.

Meanwhile, in operation, a semiconductor integrated circuit may generate a loss of a threshold voltage, thereby delaying a signal. To prevent such signal delay, a high voltage VPP having a sufficiently higher level than an external voltage level is used.

As mentioned in the above, as the integration density of the semiconductor integrated circuit increases, a number of memory cells operated simultaneously is increased, thereby increasing the VPP consumption when data is stored in and read from the cells. As a result, the VPP level decreases more and more. Therefore, a circuit for increasing the VPP level is required.

Referring to FIG. 1, the internal voltage generator for a semiconductor integrated circuit includes a level detector 100 for sensing when an internal voltage IN_VT is higher or lower than a reference voltage VREF1, a pump controller 200 for outputting a periodic pump enable signal PUMP-EN in response to a level detecting signal LEV_DET1 output from the level detector 100, and a voltage pump 300 for pumping an external supply voltage VDD or a ground voltage VSS to generate an increased or decreased internal voltage IN_VT in response to the pump enable signal PUMP_EN.

Referring to FIG. 2, the voltage pump 300 may include a first inverter IV1, a second inverter IV2, a first capacitor C1, a first diode D1, and a second diode D2. The first diode D1 and the second diode D2 are connected in a forward direction and in series between VBB and a ground voltage VSS. The periodic pump enable signal PUMP_EN charges the first capacitor C1 via the first inverter IV1 and the second inverter IV2. Accordingly, negative charges are pumped from the ground voltage VSS to VBB via the first diode D1 and the second diode D2, decreasing the VBB level.

As another example, referring to FIG. 3, the voltage pump 300 includes a third inverter IV3, a fourth inverter IV4, a second capacitor C2, a third diode D3, and a fourth diode D4. The third diode D3 and the fourth diode D4 are connected in a forward direction and in series between VDD and VPP. In the voltage pump 300, the pump enable signal PUMP_EN charges the second capacitor C2 via the third inverter IV3 and the fourth inverter IV4. This pumps positive charges from the external supply voltage VDD to VPP via the third diode D3 and the fourth diode D4, increasing the VPP level.

When a target level fed back to VBB is higher than the reference voltage VREF1, the level detector 100 outputs an enabled level detecting signal LEV_DET1. In response thereto, the pump controller 200 outputs the pump enable signal PUMP_EN. The pump enable signal PUMP_EN is input to the voltage pump 300 so that negative charges are pumped from the ground voltage VSS to VBB, pulling the VBB level down, as shown in FIG. 2.

On the other hand, when a target level fed back to VPP is lower than the reference voltage VREF1, the level detector 100 outputs the enabled level detecting signal LEV_DET1. In response thereto, the pump controller 200 outputs the pump enable signal PUMP_EN. The pump enable signal PUMP_EN is input to the voltage pump 300 shown in FIG. 3 so that positive charges are pumped from the external supply voltage VDD to VPP, thus pulling the VPP level up.

In this case, a returning time from the VBB level and the VPP level to a desired level depends on the period of the pump enable signal PUMP_EN generated by the pump controller 200. That is a number of times of pulling a voltage at one node of a bootstrap capacitance down or up in a moment determines a returning time from the VBB and VPP levels to a normal level.

In general, a periodic signal generating circuit, e.g., the pump controller 200 generates a signal whose period increases when the driving voltage level decreases.

However, when the driving voltage level decreases and the VBB level increases, a returning time from the VBB level to the normal level increases. When the driving voltage level decreases and the VPP level also decreases, a returning time from the VPP level to the normal level increases, as well.

The greater the absolute value of VBB, the greater the threshold voltage of the cell transistor is. Accordingly, for a sense amplifier (S/A) to sufficiently restore cell data through a refreshing operation, the gate voltage of the cell transistor must increase to a sufficient level.

In particular, a mobile DRAM device in which an amount of self-refresh mode current is of great importance uses a VBB level in a self-refresh mode somewhat higher than that in a normal mode to prevent deterioration of a refresh characteristic. When the self-refresh mode is exited, the VBB level returns to the normal level. However, in this method, because a well having a connection to VBB has a large capacitance, a falling time to an original VBB level gets longer.

A mobile DRAM device additionally has a deep power down (“DPD”) mode in which internal voltages are all disabled, in order to reduce power consumption. When the DPD mode is exited, the internal voltages must return to a normal level as fast as possible in a given time. Meanwhile, since the pump controller 200 uses an internal voltage as a driving voltage, a returning time of the driving voltage to the normal level is consumed and the period of the pump enable signal PUMP_EN generated by the pump controller 200 gets longer. Therefore, a rising time of the VPP level to the normal VPP level gets longer.

### SUMMARY

An embodiment of the present invention provides an internal voltage generator for a semiconductor integrated circuit that supplies a high driving voltage when a driving voltage of a pump controller is lowered.

An another embodiment of the present invention provides an internal voltage generator for a semiconductor integrated circuit which is capable of shortening a stabilizing time of an internal voltage by supplying a high driving voltage to a pump controller when a self-refresh mode and a deep power down mode are exited.

An embodiment of the present invention provides an internal voltage generator for a semiconductor integrated circuit, comprising a level detector for comparing an internal voltage with a reference voltage to output a level detecting signal; a pump controller for outputting a pump enable signal in response to a mode signal and the level detecting signal; and a voltage pump for generating the internal voltage in response to the pump enable signal.

Another embodiment of the present invention provides an internal voltage generator for a semiconductor integrated circuit comprising: a level detector for comparing an internal voltage with a first reference voltage to output a first level detecting signal; a comparator for comparing a first driving voltage with a second reference voltage to output a second detecting signal; a pump controller for outputting a pump enable signal in response to the first detecting signal and the second detecting signal; and a voltage pump for generating the internal voltage in response to the pump enable signal.

Still another embodiment of the present invention provides an internal voltage generator for a semiconductor integrated circuit comprising: a level detector for comparing an internal voltage with a first reference voltage to output a first level detecting signal; a comparator for comparing a first driving voltage with a second reference voltage to output a second detecting signal; a pump controller for outputting a pump enable signal in response to a mode signal, the first detecting signal and the second detecting signal; and a voltage pump for generating the internal voltage in response to the pump enable signal.

A further understanding of the nature and advantages of the present invention herein may be realized by reference to the remaining portions of the specification and the attached drawings.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified. In the figures:

FIG. 1 is a block diagram of a conventional internal voltage generator for a semiconductor integrated circuit;

FIG. 2 is a diagram of a VBB pumping circuit used as an example of a voltage pump shown in FIG. 1;

FIG. 3 is a diagram of a VBB pumping circuit used as another example of a voltage pump shown in FIG. 1;

FIG. 4 is a block diagram of an internal voltage generator for a semiconductor integrated circuit according to an embodiment of the present invention;

FIG. 5 is a block diagram of a pump controller shown in FIG. 4;

FIG. 6 is a circuit diagram of a signal input circuit shown in FIG. 5;

FIG. 7 is a block diagram illustrating an example of a clock period controller according to an embodiment of the present invention;

FIG. 8 is a circuit diagram of a clock period controller shown in FIG. 7;

FIG. 9 is a block diagram illustrating another example of a clock period controller according to an embodiment of the present invention;

FIG. 10 is a circuit diagram of the clock period controller shown in FIG. 9;

FIG. 11 is a timing diagram illustrating an operation in a self-refresh mode according to an embodiment of the present invention;

FIG. 12 is a timing diagram illustrating an operation in a deep power down mode according to an embodiment of the present invention;

FIG. 13 is a block diagram of an internal voltage generator for a semiconductor integrated circuit according to another embodiment of the present invention;

FIG. 14 is a circuit diagram of a comparator shown in FIG. 13;

FIG. 15 is a block diagram of an internal voltage generator of a semiconductor integrated circuit according to another embodiment of the present invention;

FIG. 16 is a block diagram of a pump controller shown in FIG. 15;

FIG. 17 is a block diagram of a signal input circuit shown in FIG. 16; and

FIG. 18 is a circuit diagram of a signal input circuit shown in FIG. 17.

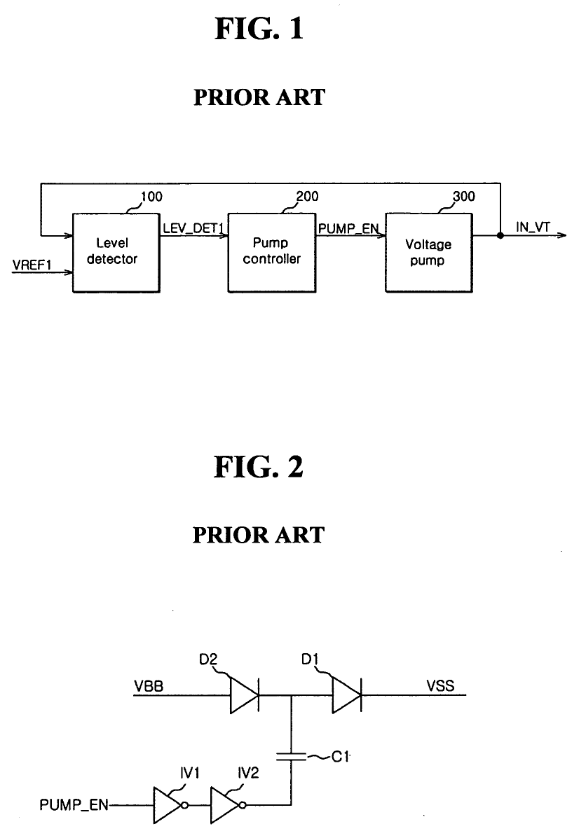

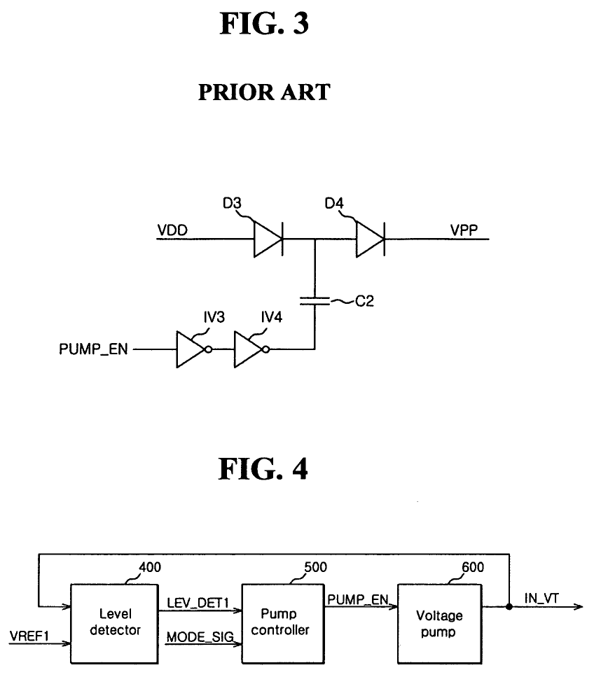

### DETAILED DESCRIPTION OF EXEMPLARY EMBODIMENT

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Like reference numerals refer to like elements throughout the accompanying figures.

Referring to FIG. 4, an internal voltage generator for a semiconductor integrated circuit includes a level detector 400 for comparing an internal voltage IN_VT with a reference voltage VREF1, to output a level detecting signal LEV_DET1; a pump controller 500 for outputting a pump enable signal PUMP_EN in response to a mode signal MODE_SIG and the level detecting signal LEV_DET1, and a voltage pump 600 for generating the internal voltage IN_VT in response to the pump enable signal PUMP_EN.

The internal voltage IN_VT may represent a bulk voltage VBB or a high voltage VPP.

The mode signal MODE_SIG may be a self-refresh mode signal SREF when the internal voltage IN_VT is the VBB and a deep power down mode signal DPD when the internal voltage IN_VT is the VPP.

The level of the first reference voltage VREF1 upon generating VBB differs from that upon generating VPP.

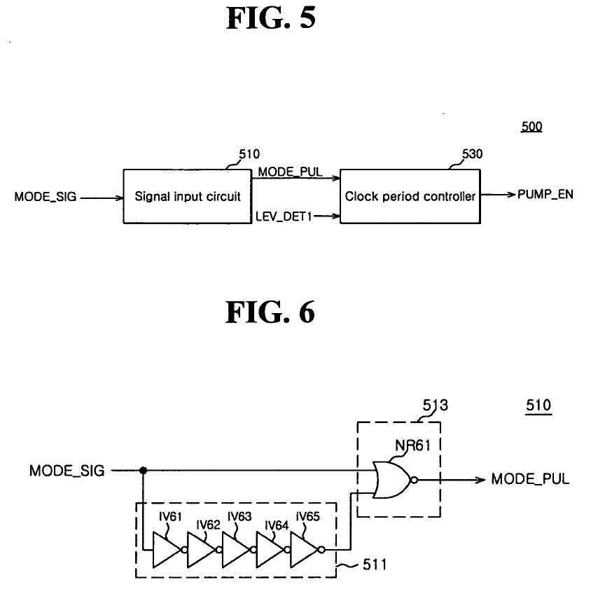

Referring to FIG. 5, the pump controller 500 includes a signal input circuit 510 for generating and outputting a mode pulse signal MODE_PUL in response to the mode signal MODE_SIG and the mode pulse signal MODE_PUL being enabled when the mode signal MODE_SIG is disabled; and a clock period controller 530 for adjusting the period of the pump enable signal PUMP_EN in response to the mode pulse signal MODE_PUL and the level detecting signal LEV_DET1.

Referring to FIG. 6, the signal input circuit 510 includes an inverting and delaying unit 511 for inverting and delaying the mode signal MODE_SIG, to output a delayed inverted signal MODE_SIG_DELb; and a signal combining unit 513 for performing a logical operation on the mode signal MODE_SIG and the delayed inverted signal MODE_SIG_DELb, to output the enabled mode pulse signal MODE_PUL. The inverting and delaying unit 511 may include five inverting units IV61 to IV65, and the signal combining unit 513 may include a NOR gate NR61. While the inverting and delaying unit 511 includes the five inverting units IV61 to IV65, it may include any odd number of inverting units connected in series. Alternatively, the signal combining unit 513 may include a logic device capable of performing the NOR operation. Alternatively, the signal input circuit 510 may be any of various pulse generating circuits.

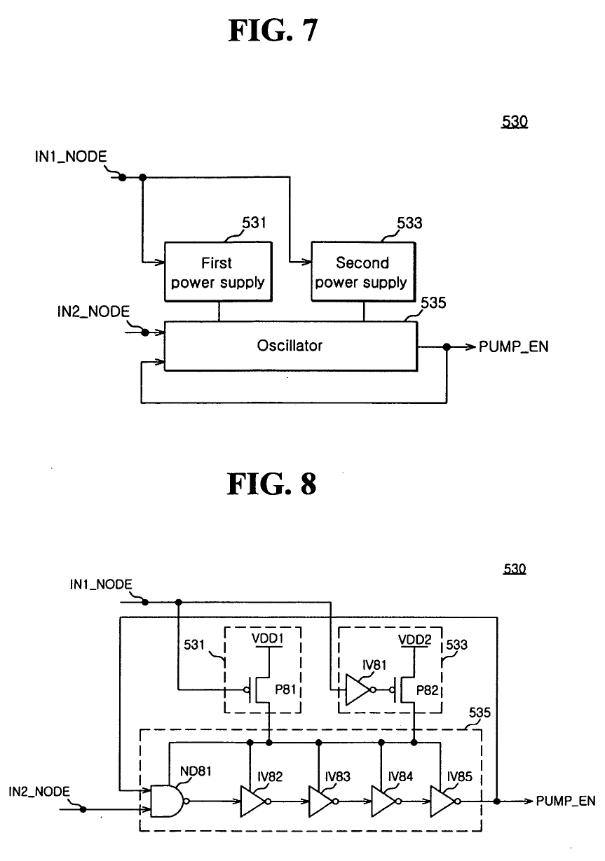

Referring to FIG. 7, the clock period controller 530 receives the mode pulse signal MODE_PUL at a first input IN1_NODE thereof and the level detecting signal LEV_DET1 at a second input IN2_NODE thereof. The clock period controller 530 includes a first power supply circuit 531 for supplying a first driving voltage VDD1 when the mode pulse signal MODE_PUL is disabled; a second power supply circuit 533 for supplying a second driving voltage VDD2 when the mode pulse signal MODE_PUL is enabled; and an oscillator 535 for generating the pump enable signal PUMP_EN whose period is adjusted in response to the level detecting signal LEV_DET1 and the pump enable signal PUMP_EN. The oscillator 535 selectively supplied with either the first driving voltage VDD1 or the second driving voltage VDD2.

The second driving voltage VDD2 is higher than the first driving voltage VDD1. For example, the first driving voltage VDD1 may be an external supply voltage VDD and the second driving voltage VDD2 may be a high voltage VPP.

The first driving voltage VDD1 and the second driving voltage VDD2 are not limited to the internal or external voltage.

Referring to FIG. 8, the first power supply circuit 531 includes a first PMOS transistor P81 for providing the first driving voltage VDD1 to the oscillator 535 in response to the mode pulse signal MODE_PUL. The second power supply circuit 533 includes a second PMOS transistor P82 for providing the second driving voltage VDD2 to the oscillator 535 in response to the inverted mode pulse signal MODE_PUL. The second power supply circuit 533 further includes a first inverter IN81 for inverting the mode pulse signal MODE_PUL. The oscillator 535 includes a NAND gate ND81 responsive to the level detecting signal LEV_DET1 and the pump enable signal PUMP_EN, and second to fifth inverters IV82 to IV85 for subsequently inverting an output signal of the NAND gate ND81.

Alternatively, the first power supply circuit 531 and the second power supply circuit 533 may include a switching device responsive to the mode pulse signal MODE_PUL.

Although, the oscillator 535 includes four inverting units, the oscillator 535 may include any even number of inverting units.

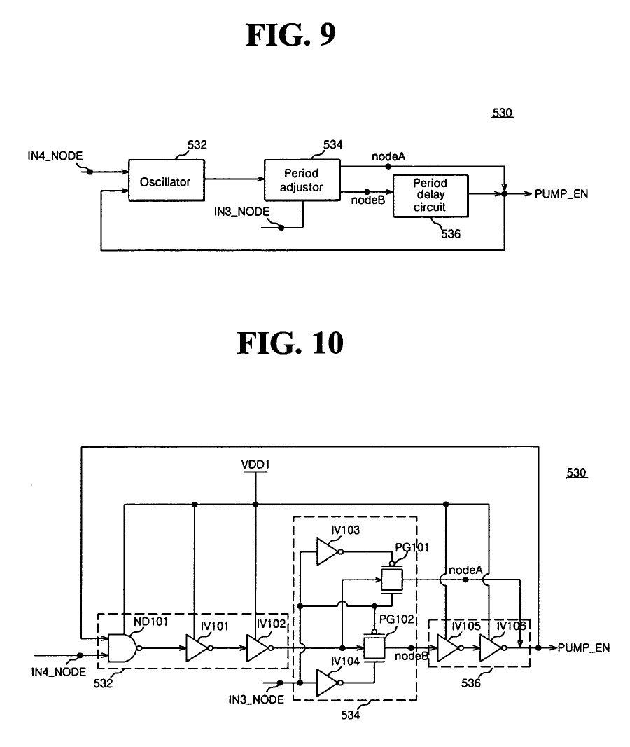

Another example of the clock period controller 530 will be described with reference to FIG. 9. The clock period controller 530 may include an oscillator 532, a period adjustor 534, and a period delay circuit 536. The mode pulse signal MODE_PUL and the pump enable signal PUMP_EN are input to the oscillator 532. The period adjustor 534 selects the pump enable signal PUMP_EN on either a first node A or a second node B in response to the mode pulse signal MODE_PUL. The period delay circuit 536 delays the period of the pump enable signal PUMP_EN on the second node B, to output a second pump enable signal PUMP2_EN.

The first pump enable signal PUMP1_EN is output as the pump enable signal PUMP_EN on the first node A, and the second pump enable signal PUMP2_EN is output as the pump enable signal PUMP_EN via the period delay circuit 536. That is, the pump enable signal PUMP_EN may include the first pump enable signal PUMP1_EN and the second pump enable signal PUMP2_EN.

Referring to FIG. 10, the oscillator 532 includes a NAND gate ND101 received the level detecting signal LEV_DET1 and the pump enable signal PUMP_EN, and first and second inverters IV101 and IV102 for subsequently inverting an output signal of the NAND gate ND101.

The period adjustor 534 includes third and the fourth inverters IV103 and IV104 for inverting the mode pulse signal MODE_PUL, and first and second transfer gates PG101 and PG102 controlled by the mode pulse signal MODE_PUL.

The period delay circuit 536 includes a fifth inverter IV105 and a sixth inverter IV106.

Although the oscillator 532 of the embodiment of the present invention may include two inverting units, the oscillator 523 may include any even number of the inverting units. Alternatively, the period delay circuit 536 may include any even number of inverting units. The period adjustor 534 may include any logic device or circuit capable of selectively outputting the pump enable signal PUMP_EN on any one of the two nodes in response to the mode pulse signal MODE_PUL.

Operation of the internal voltage generator in the semiconductor integrated circuit according to an embodiment of the present invention will be described.

It is assumed that the generated internal voltage IN_VT is VBB and the mode signal MODE_SIG is a self-refresh mode signal SREF of the semiconductor integrated circuit.

In a self-refresh mode of the semiconductor integrated circuit, a VBB level higher than a normal level (reference voltage) is used. The operation for lowering the VBB level is initiated when the self-refresh mode ends.

The level detector 400 detects the VBB level having a voltage level higher than the reference voltage VREF1 and outputs an enabled level detecting signal LEV_DET1. The pump controller 500 receives the enabled level detecting signal LEV_DET1 and the self-refresh mode signal SREF.

The signal input circuit 510 of the pump controller 500 detects a timing that the self-refresh mode signal SREF is disabled, and outputs the mode pulse signal MODE_PUL when the self-refresh mode signal SREF is disabled. That is the signal input circuit 510 outputs the enabled mode pulse signal MODE_PUL using the inverting and delaying unit 511 and the signal combining unit 513.

Referring to FIG. 7 and FIG. 8, the clock period controller 530 receives the mode pulse signal MODE_PUL and the level detecting signal LEV_DET1 and adjusts a period of the pump enable signal PUMP_EN. The mode pulse signal MODE_PUL is input to the first input terminal IN1_NODE of the clock period controller 530, and the level detecting signal LEV-DET1 is input to the second input terminal IN2_NODE.

The first power supply circuit 531 outputs the first driving voltage VDD1 before the mode pulse signal MODE_PUL is enabled, but the second power supply circuit 533 supplies the second driving voltage VDD2 higher than the first driving voltage VDD1 to the oscillator 535 when the mode pulse signal MODE_PUL is enabled.

The oscillator 535 is supplied with the second driving voltage VDD2 when the mode pulse signal MODE_PUL is enabled, and begins to generate the pump enable signal PUMP_EN when the first level detecting signal LEV_DET1 from the level detector 400 is enabled.

A periodic signal generating circuit such as the oscillator 535 generates a periodic signal having a short period when the driving voltage is high, and a periodic signal having a long period when the driving voltage is low. Accordingly, the period of the pump enable signal PUMP_EN output from the oscillator 535 gets shorter when the second driving voltage VDD2 is input to the oscillator 535 than when the first driving voltage VDD1 is input thereto.

The voltage pump 600 receives the pump enable signal PUMP_EN, which is output from the oscillator 535 responsive to the second driving voltage VDD2. Thus the voltage pump 600 can reduce a falling time of the elevated VBB level to its normal level.

Another example of the clock period controller 530 will be described with reference to FIGS. 9 and 10.

The mode pulse signal MODE_PUL is input to the third input terminal IN3_NODE of the clock period controller 530, and the level detecting signal LEV_DET1 is input to the fourth input terminal IN4_NODE of the clock period controller 530.

The oscillator 532 outputs the pump enable signal PUMP_EN in response to the level detecting signal LEV_DET1 and the pump enable signal PUMP_EN. In response to the mode pulse signal MODE_PUL, the period adjustor 534 outputs the pump enable signal PUMP_EN to the first node A and the second node B. The period delay circuit 536 delays the pump enable signal PUMP_EN on the second node B.

The period of the pump enable signal PUMP_EN can be adjusted depending on the number of the inverters in the period adjustor 534.

That is, when the mode pulse signal MODE_PUL is enabled, to make the period of the pump enable signal PUMP_EN shorter, the pump enable signal PUMP_EN is generated by the NAND gate ND101 and the two inverting units IV101 and IV102 and output to the first node A. When the mode pulse signal MODE_PUL is disabled, to make the period of the pump enable signal PUMP_EN longer, the pump enable signal PUMP_EN is generated by the NAND gate ND101 and the four inverting units IV101, IV102, IV105, and IV106.

The voltage pump 600 can reduce a falling time of the VBB level to its normal level in response to the pump enable signal PUMP_EN on the first node A.

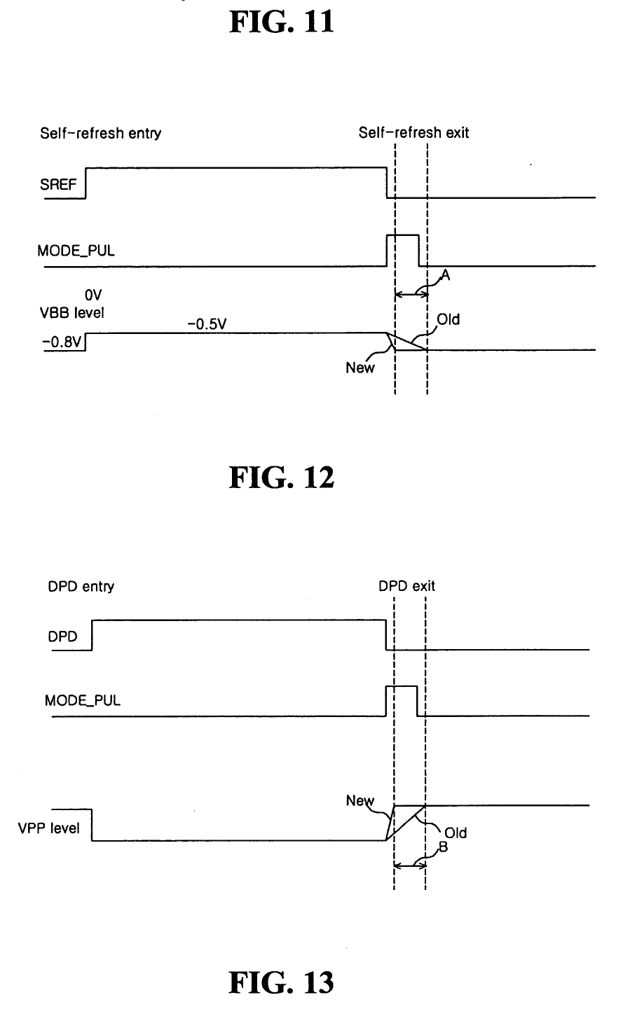

Referring to FIG. 11, in a self-refresh mode, the signal input circuit 511 outputs the mode pulse signal MODE_PUL when the self-refresh mode signal SREF is disabled.

As shown in FIG. 8, the second PMOS transistor P82 of the second power supply circuit 533 is turned on by the mode pulse signal MODE_PUL, and the second driving voltage VDD2 higher than the first driving voltage VDD1 is input to the oscillator 535, thus making the period of the pump enable signal PUMP_EN shorter.

As shown in FIG. 10, the first transfer gate PG101 of the period adjustor 534 is also turned on. This reduces the number of the inverting units used for generating the pump enable signal PUMP_EN, making the period of the pump enable signal PUMP_EN shorter.

The falling time of the VBB level can be shortened by a period of time A in the voltage pump 600, which is responsive to the pump enable signal PUMP_EN, as compared to the case in which the first driving voltage VDD1 is used as it is.

Hereinafter operation of the internal voltage generator will be described if the generated internal voltage IN_VT is VPP and the mode signal MODE_SIG is a deep power down mode signal DPD.

If the semiconductor integrated circuit enters a deep power down mode, an internal power is disabled, thereby reducing a VPP level. An operation for elevating the VPP level is initiated when the deep power down mode ends.

The level detector 400 detects the VPP level lower than the first reference voltage VREF1 and activates the level detecting signal LEV_DET1. The pump controller 500 receives the enabled level detecting signal LEV_DET1 and the deep power down mode signal DPD.

The signal input circuit 510 of the pump controller 500 detects a timing that the deep power down mode signal DPD is disabled, and outputs the mode pulse signal MODE_PUL that is enabled when the deep power down mode signal DPD is disabled. That is the signal input circuit 510 outputs the enabled mode pulse signal MODE_PUL using the inverting and delaying unit 511 and the signal combining unit 513.

Referring to FIG. 7 and FIG. 8, the clock period controller 530 adjusts the period of the output pump enable signal PUMP_EN in response to the mode pulse signal MODE_PUL and the level detecting signal LEV_DET1.

The mode pulse signal MODE_PUL is input to the first input terminal IN1_NODE of the clock period controller 530, and the level detecting signal LEV_DET1 is input to the second input terminal IN2_NODE of the clock period controller 530.

The first power supply circuit 531 outputs the first driving voltage VDD1 before the mode pulse signal MODE_PUL is enabled, but the second power supply circuit 533 supplies the second driving voltage VDD2 higher than the first driving voltage VDD1 to the oscillator 535 when the mode pulse signal MODE_PUL is enabled.

The oscillator 535 is supplied with the second driving voltage VDD2 when the mode pulse signal MODE_PUL is enabled, and begins to generate the pump enable signal PUMP_EN when the first level detecting signal LEV_DET1 from the level detector 400 is enabled.

A periodic signal generating circuit, such as the oscillator 535 generates a periodic signal having a shorter period when the driving voltage is high and a periodic signal having a longer period when the driving voltage is low. In this manner, the period of the pump enable signal PUMP_EN output from the oscillator 535 gets shorter when the second driving voltage VDD2 is input to the oscillator 535 than when the first driving voltage VDD1 is input thereto.

The voltage pump 600 can reduce a falling time of the VBB level to its normal level in response to the pump enable signal PUMP_EN, which is output from the oscillator 535 responsive to the second driving voltage VDD2.

Another example of the clock period controller 530 will be described with reference to FIGS. 9 and 10.

The mode pulse signal MODE_PUL is input to the third input terminal IN3_NODE of the clock period controller 530, and the level detecting signal LEV_DET1 is input to the fourth input terminal IN4_NODE of the clock period controller 530.

The oscillator 532 outputs the pump enable signal PUMP_EN in response to the level detecting signal LEV_DET1 and the pump enable signal PUMP_EN. In response to the mode pulse signal MODE_PUL, the period adjustor 534 outputs the pump enable signal PUMP_EN to the first node A and the second node B. The period delay circuit 536 delays the pump enable signal PUMP_EN on the second node B.

The period of the pump enable signal PUMP_EN can be adjusted depending on the number of the inverters in the period adjustor 534.

That is when the mode pulse signal MODE_PUL is enabled, to make the period of the pump enable signal PUMP_EN shorter, the pump enable signal PUMP_EN is generated by the NAND gate ND101 and the two inverting units IV101 and IV102 and output to the first node A. When the mode pulse signal MODE_PUL is disabled, to make the period of the pump enable signal PUMP_EN longer, the pump enable signal PUMP_EN is generated by the NAND gate ND101 and the four inverting units IV101, IV102, IV105, and IV106.

The voltage pump 600 can reduce a rising time of the VBB level to its normal level in response to the pump enable signal PUMP_EN on the first node A.

FIG. 12 is a timing diagram illustrating an exemplary operation in a deep power down mode.

In a deep power down mode, the signal input circuit 511 outputs the mode pulse signal MODE_PUL when a deep power down mode signal DPD is disabled.

As shown in FIG. 8, the second PMOS transistor P82 of the second power supply circuit 533 is turned on by the mode pulse signal MODE_PUL, and the second driving voltage VDD2 higher than the first driving voltage VDD1 is input to the oscillator 535, thus making the period of the pump enable signal PUMP_EN shorter.

As shown in FIG. 10, the first transfer gate PG101 of the period adjustor 534 is also turned on. This reduces the number of the inverting units used for generating the pump enable signal PUMP_EN, making the period of the pump enable signal PUMP_EN shorter.

The falling time of the VBB level to its normal level can be shortened by a period of time B by the voltage pump 600, which is responsive to the pump enable signal PUMP_EN, as compared to the case in which the first driving voltage VDD1 is used as it is.

FIG. 13 is a block diagram of an internal voltage generator for a semiconductor integrated circuit according to another embodiment of the present invention.

The internal voltage generator for a semiconductor integrated circuit includes a level detector 400 for comparing an internal voltage IN_VT with a first reference voltage VREF1 to output a first level detecting signal LEV_DET1; a comparator 450 for comparing a first driving voltage VDD1 with a second reference voltage VREF2 to output a second level detecting signal LEV_DET2; a pump controller 500 for outputting a pump enable signal PUMP_EN in response to the first level detecting signal LEV_DET1 and the second level detecting signal LEV_DET2; and a voltage pump 600 for generating the internal voltage IN_VT in response to the pump enable signal PUMP_EN.

The internal voltage IN_VT may represent a bulk voltage VBB or a high voltage VPP.

The level of the first reference voltage VREF1 upon generating VBB differs from that upon generating VPP.

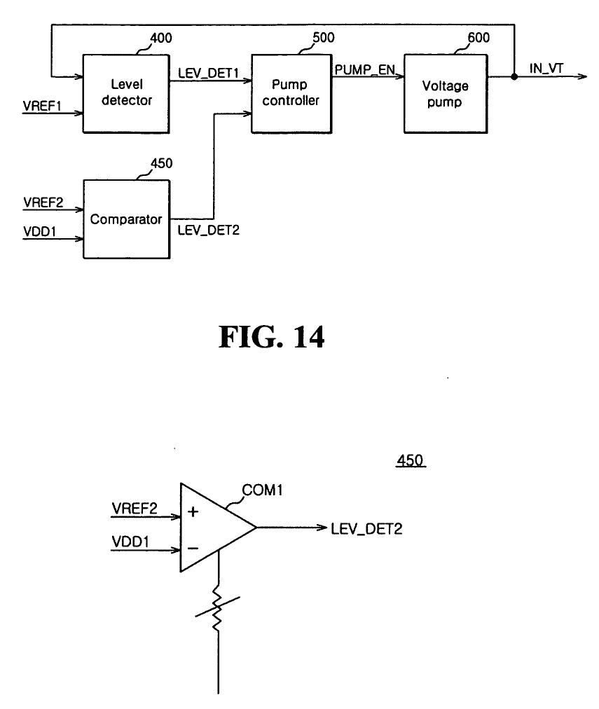

Referring to FIG. 14, the comparator 450 includes a comparator COM1 for enabling the second level detecting signal LEV_DET2 when the first driving voltage VDD1 is lower than the second reference voltage VREF2.

For example, the pump controller 500 may be configured as shown in FIG. 7. The pump controller 500 receives the second level detecting signal LEV_DET2 at a first input IN1_NODE thereof and the first level detecting signal LEV_DET1 at a second input IN2_NODE thereof.

The pump controller 500 includes a first power supply circuit 531 for supplying a first driving voltage VDD1 when the second level detecting signal LEV_DET2 is disabled; a second power supply circuit 533 for supplying a second driving voltage VDD2 when the second level detecting signal LEV_DET2 is enabled; and an oscillator 535 selectively supplied with either the first driving voltage VDD1 or the second driving voltage VDD2 for generating a pump enable signal PUMP_EN in response to the level detecting signal LEV_DET1 and the pump enable signal PUMP_EN.

The second driving voltage VDD2 is higher than the first driving voltage VDD1. For example, the first driving voltage VDD1 may be an external supply voltage VDD and the second driving voltage VDD2 may be a high voltage VPP.

The first driving voltage VDD1 and the second driving voltage VDD2 are not limited to the internal or external voltage.

The pump controller 500 may be configured as shown in FIG. 8. The pump controller 500 receives the second level detecting signal LEV_DET2 at the first input IN1_NODE and the first level detecting signal LEV_DET1 at the second input IN2_NODE.

Referring to FIG. 8, the first power supply circuit 531 includes a first PMOS transistor P81 for providing the first driving voltage VDD1 to the oscillator 535 in response to the second level detecting signal LEV_DET2.

The second power supply circuit 533 includes a first inverter IN81 for inverting the second level detecting signal LEV_DET2, and a second PMOS transistor P82 for providing the second driving voltage VDD2 to the oscillator 535 in response to the second inverted level detecting signal LEV_DET2b.

The oscillator 535 includes a NAND gate ND81 responsive to the first level detecting signal LEV_DET1 and the pump enable signal PUMP_EN, and second to fifth inverters IV82 to IV85 for subsequently inverting an output signal of the NAND gate ND81.

Alternatively, the first power supply circuit 531 and the second power supply circuit 533 may include a switching device responsive to the second level detecting signal LEV_DET2.

Alternatively, the oscillator 535 may include any even number of inverting units.

In another example, the pump controller 500 may be configured as shown in FIG. 9. The pump controller 500 receives the second level detecting signal LEV_DET2 at the third input IN3_NODE thereof and the first level detecting signal LEV_DET1 at the fourth input IN4_NODE thereof.

The pump controller 500 includes an oscillator 532 for outputting the pump enable signal PUMP_EN in response to the first level detecting signal LEV_DET1 and the pump enable signal PUMP_EN, a period adjustor 534 for selectively outputting the pump enable signal PUMP_EN on either a first node A or a second node B in response to the second level detecting signal LEV_DET2, and a period delay circuit 536 for delaying the period of the pump enable signal PUMP_EN on the second node B to output a second pump enable signal PUMP2_EN.

The first pump enable signal PUMP1_EN is output as the pump enable signal PUMP_EN on the first node A, and the second pump enable signal PUMP2_EN is output as the pump enable signal PUMP_EN via the period delay circuit 536. That is, the pump enable signal PUMP_EN includes the first pump enable signal PUMP1_EN and the second pump enable signal PUMP2_EN.

The pump controller 500 may be configured as shown in FIG. 10. The pump controller 500 receives the second level detecting signal LEV_DET2 at a third input IN3_NODE thereof and the first level detecting signal LEV_DET1 at a fourth input IN4_NODE thereof.

Referring to FIG. 10, the oscillator 532 includes a NAND gate ND101 responsive to the first level detecting signal LEV_DET1 and the pump enable signal PUMP_EN, and first and second inverters IV101 and IV102 for subsequently inverting an output signal of the NAND gate ND101.

The period adjustor 534 includes third and the fourth inverters IV103 and IV104 for inverting the second level detecting signal LEV_DET2, and first and second transfer gates PG101 and PG102 controlled by the second level detecting signal LEV_DET2.

The period delay circuit 536 includes a fifth inverter IV105 and a sixth inverter IV106.

Although the oscillator 532 of the embodiment includes two inverting unit, the oscillator 532 may include any even number of inverting units. The period delay circuit 536 may include any even number of inverting units.

Alternatively, the period adjustor 534 may include any logic device or circuit capable of selectively outputting the pump enable signal PUMP_EN on any one of the two nodes in response to the second level detecting signal LEV_DET2.

Operation of the internal voltage generator for a semiconductor integrated circuit according to another embodiment of the present invention will be described.

If the VBB level increases from its normal level or the VPP level decreases from its normal level, since the semiconductor integrated circuit is operated for a long time, the internal voltage generator operates to pull the VBB level down and the VPP level up.

The level detector 400 enables the first level detecting signal LEV_DET1 when the internal voltage IN_VT is not in a normal level.

The comparator 450 compares the first driving voltage VDD1 level for driving the pump controller 500 with the second reference voltage VREF2 level, and outputs the second level detecting signal LEV_DET2 when the first driving voltage VDD1 is lower than the second reference voltage VREF2.

The pump controller 500 adjusts the period of the pump enable signal PUMP_EN in response to the first level detecting signal LEV_DET1 and the second level detecting signal LEV_DET2, which will be described with reference to FIGS. 7 and 8 illustrating an example of the pump controller 500.

The second level detecting signal LEV_DET2 is input to the first input terminal IN1_NODE of the pump controller 500, and the first level detecting signal LEV_DET1 is input to the second input terminal IN2_NODE of the pump controller 500.

The first power supply circuit 531 outputs the first driving voltage VDD1 before the second level detecting signal LEV_DET2 is enabled, but the second power supply circuit 533 supplies the second driving voltage VDD2 higher than the first driving voltage VDD1 to the oscillator 535 when the second level detecting signal LEV_DET2 is enabled.

The oscillator 535 is supplied with the second driving voltage VDD2 when the second level detecting signal LEV_DET2 is enabled, and begins to generate the pump enable signal PUMP_EN when the first level detecting signal LEV_DET1 from the level detector 400 is enabled.

A periodic signal generating circuit, such as the oscillator 535 generates a periodic signal having a shorter period when the driving voltage is high and a periodic signal having a longer period when the driving voltage is low. In this manner, the period of the pump enable signal PUMP_EN output from the oscillator 535 gets shorter when the second driving voltage VDD2 is input to the oscillator 535 than when the first driving voltage VDD1 is input thereto.

The voltage pump 600 can reduce a falling time of the VBB level to its normal level in response to the pump enable signal PUMP_EN, which is output from the oscillator 535 responsive to the second driving voltage VDD2.

The operation will be described with reference to FIGS. 9 and 10 illustrating another example of the pump controller 500.

The second level detecting signal LEV_DET2 is input to the third input terminal IN3_NODE of the pump controller 500, and the first level detecting signal LEV_DET1 is input to the fourth input terminal IN4_NODE of the pump controller 500.

The oscillator 532 outputs the pump enable signal PUMP_EN in response to the first level detecting signal LEV_DET1 and the pump enable signal PUMP_EN. In response to the second level detecting signal LEV_DET2, the period adjustor 534 outputs the pump enable signal PUMP_EN to the first node A and the second node B. The period delay circuit 536 delays the pump enable signal PUMP_EN on the second node B.

The period of the pump enable signal PUMP_EN can be adjusted depending on the number of the inverters in the period adjustor 534.

That is, when the second level detecting signal LEV_DET2 is enabled, to make the period of the pump enable signal PUMP_EN shorter, the pump enable signal PUMP_EN is generated by the NAND gate ND101 and the two inverting units IV101 and IV102 and output to the first node A, and when the second level detecting signal LEV_DET2 is disabled, to make the period of the pump enable signal PUMP_EN longer, the pump enable signal PUMP_EN is generated by the NAND gate ND101 and the four inverting units IV101, IV102, IV105, and IV106.

The voltage pump 600 can reduce a falling time of the VBB level to its normal level and a rising time of the VPP level to its normal level in response to the pump enable signal PUMP_EN on the first node A.

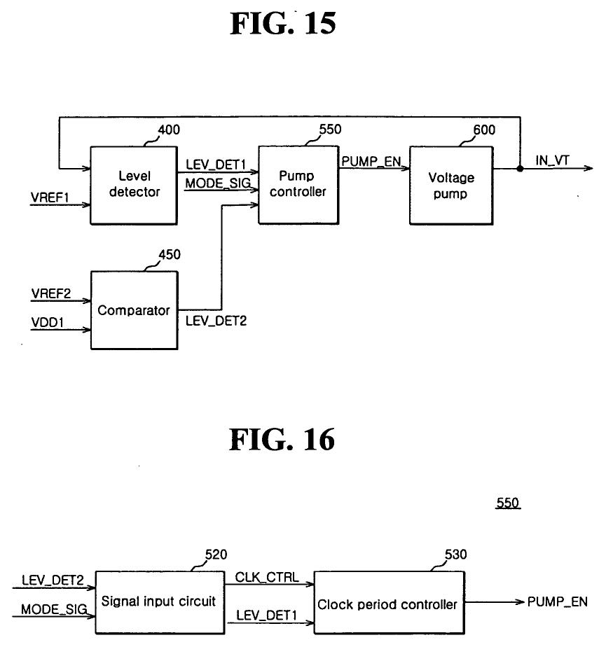

FIG. 15 is a block diagram of an internal voltage generator of a semiconductor integrated circuit according to another embodiment of the present invention.

An internal voltage generator for a semiconductor integrated circuit according to another embodiment of the present invention includes a level detector 400 for comparing an internal voltage IN_VT with a first reference voltage VREF1 to output a first level detecting signal LEV_DET1; a comparator 450 for comparing a first driving voltage VDD1 with a second reference voltage VREF2 to output a second level detecting signal LEV_DET2; a pump controller 550 for outputting a pump enable signal PUMP_EN in response to a mode signal MODE_SIG, the first level detecting signal LEV_DET1 and the second level detecting signal LEV_DET2; and a voltage pump 600 for generating the internal voltage IN_VT in response to the pump enable signal PUMP_EN.

The internal voltage IN_VT may represent a bulk voltage VBB or a high voltage VPP.

The mode signal MODE_SIG may represent a self-refresh mode signal SREF when the internal voltage IN_VT is VBB and a deep power down mode signal DPD when the internal voltage IN_VT is VPP.

The level of the first reference voltage VREF1 upon generating VBB differs from that upon generating VPP.

Referring to FIG. 14, the comparator 450 includes a comparator COM1 for enabling the second level detecting signal LEV_DET2 when the first driving voltage VDD1 is lower than the second reference voltage VREF2.

Referring to FIG. 16, the pump controller 550 includes a signal input circuit 520 for outputting a clock period control signal CLK_CTRL in response to the second level detecting signal LEV_DET2 and the mode signal MODE_SIG; and a clock period controller 530 for generating the pump enable signal PUMP_EN whose period is adjusted in response to the clock period control signal CLK_CTRL and the first level detecting signal LEV_DET1.

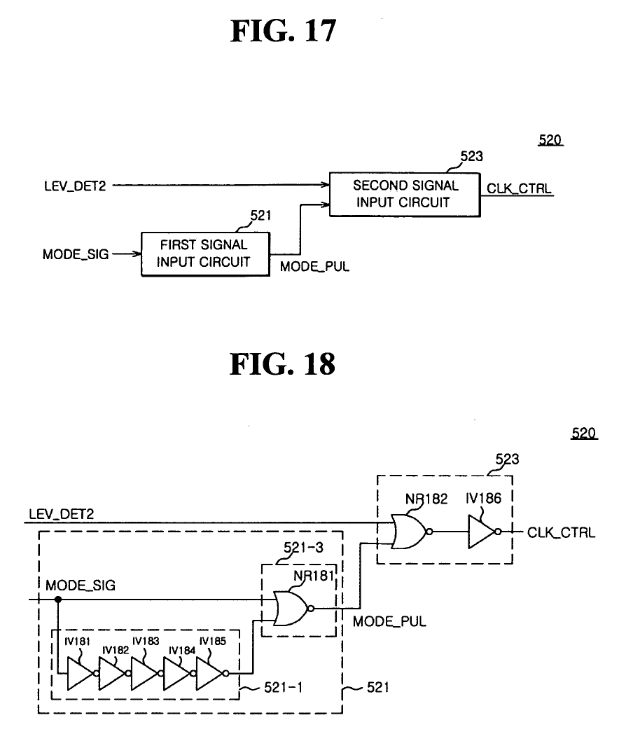

Referring to FIG. 17, the signal input circuit 520 includes a first signal input circuit 521 for generating and outputting a mode pulse signal MODE_PUL in response to the mode signal MODE_SIG, the mode pulse signal MODE_PUL being enabled when the mode signal MODE_SIG is disabled; and a second signal input circuit 523 for outputting the clock period control signal CLK_CTRL in response to the mode pulse signal MODE_PUL and the second level detecting signal LEV_DET2.

Referring to FIG. 18, the first signal input circuit 521 includes an inverting and delaying unit 521-1 for outputting a delayed inverted signal MODE_SIG_DELb obtained by inverting and delaying the mode signal MODE_SIG, and a signal combining unit 521-3 for performing a logical operation on the mode signal MODE_SIG and the delayed inverted signal MODE_SIG_DELb to output the enabled mode pulse signal MODE_PUL.

The second signal input circuit 523 includes a NOR gate NR182 responsive to the second level detecting signal LEV_DET2 and the mode pulse signal MODE_PUL; and an inverting unit IV186 for inverting an output signal of the NOR gate NR182. The inverting and delaying unit 521-1 may include five inverting units IV181 to IV185, and the signal combining unit 513-1 may include a NOR gate NR181.

While the inverting and delaying unit 521-1 includes the five inverting unit IV181 to IV185, it may include any odd number of inverting units connected in series. Alternatively, the signal combining unit 521-3 may include other logic device capable of performing the NOR operation.

For example, the clock period controller 530 shown in FIG. 16 may be configured as shown in FIG. 7. The clock period controller 530 receives the clock period control signal CLK_CTRL at the first input IN1_NODE thereof and the first level detecting signal LEV_DET1 at the second input IN2_NODE thereof.

The clock period controller 530 includes a first power supply circuit 531 for supplying a first driving voltage VDD1 when the clock period control signal CLK_CTRL is disabled, a second power supply circuit 533 for supplying a second driving voltage VDD2 when the clock period control signal CLK_CTRL is enabled, and an oscillator 535 selectively supplied with either the first driving voltage VDD1 or the second driving voltage VDD2 for generating the pump enable signal PUMP_EN in response to the first level detecting signal LEV_DET1 and the pump enable signal PUMP_EN.

The second driving voltage VDD2 is higher than the first driving voltage VDD1. For example, the first driving voltage VDD1 may be an external supply voltage VDD and the second driving voltage VDD2 may be a high voltage VPP.

The first driving voltage VDD1 and the second driving voltage VDD2 are not limited to the internal or external voltage.

The clock period controller 530 may be configured as shown in FIG. 8. The clock period controller 530 receives the clock period control signal CLK_CTRL at the first input IN1_NODE thereof and the first level detecting signal LEV_DET1 at the second input IN2_NODE thereof.

The first power supply circuit 531 includes a first PMOS transistor P81 for providing the first driving voltage to the oscillator 535 in response to the clock period control signal CLK_CTRL.

The second power supply circuit 533 includes a first inverter IV81 for inverting the clock period control signal CLK_CTRL, and a second PMOS transistor P82 for providing the second driving voltage VDD2 to the oscillator 535 connected to a drain thereof in response to the inverted clock period control signal CLK_CTRLb at a gate thereof and the second driving voltage VDD2 at a source thereof

The oscillator 535 includes a NAND gate ND81 responsive to the first level detecting signal LEV_DET1 and the pump enable signal PUMP_EN, and second to fifth inverters IV82 to IV85 for subsequently inverting an output signal of the NAND gate ND81.

Alternatively, the first power supply circuit 531 and the second power supply circuit 533 may include a switching device responsive to the clock period control signal CLK_CTRL.

Alternatively, the oscillator 535 may include an even number of inverting units.

In another example, the clock period controller 530 may be configured as shown in FIG. 9. The clock period controller 530 receives the clock period control signal CLK_CTRL at the third input IN3_NODE and the first level detecting signal LEV_DET1 at the fourth input IN4_NODE.

The clock period controller 530 may include an oscillator 532 for outputting the pump enable signal PUMP_EN in response to the first level detecting signal LEV_DET1 and the pump enable signal PUMP_EN, a period adjustor 534 for selectively outputting the pump enable signal PUMP_EN on either a first node A or a second node B in response to the clock period control signal CLK_CTRL, and a period delay circuit 536 for delaying the period of the pump enable signal PUMP_EN from the second node B to output a second pump enable signal PUMP2_EN.

The first pump enable signal PUMP1_EN is output as the pump enable signal PUMP_EN on the first node A, and the second pump enable signal PUMP2_EN is output as the pump enable signal PUMP_EN via the period delay circuit 536. That is, the pump enable signal PUMP_EN includes the first pump enable signal PUMP _EN and the second pump enable signal PUMP2_EN.

The clock period controller 530 may be configured as shown in FIG. 10. The clock period controller 530 receives the clock period control signal CLK_CTRL at the third input IN3_NODE and the first level detecting signal LEV_DET1 at the fourth input IN4_NODE.

Referring to FIG. 10, the oscillator 532 includes a NAND gate ND101 responsive to the first level detecting signal LEV_DET1 and the pump enable signal PUMP_EN, and first and second inverters IV101 and IV102 for subsequently inverting an output signal of the NAND gate ND101.

The period adjustor 534 includes third and fourth inverters IV103 and IV104 for inverting the clock period control signal CLK_CTRL, and first and second transfer gates PG101 and PG102 controlled by the clock period control signal CLK_CTRL.

The period delay circuit 536 includes a fifth inverter IV105 and a sixth inverter IV106.

Alternatively, the oscillator 532 may include an even number of inverting units, and the period delay circuit 536 may include any even number of inverting units.

Alternatively, the period adjustor 534 may include any logic device or circuit capable of selectively outputting the pump enable signal PUMP_EN on any one of the two nodes in response to the clock period control signal CLK_CTRL.

Operation of the internal voltage generator for a semiconductor integrated circuit according to another embodiment of the present invention will be described.

It is assumed that a generated internal voltage IN_VT is VBB, and the mode signal MODE_SIG is a self-refresh mode signal SREF of the semiconductor integrated circuit.

In a self-refresh mode of the semiconductor integrated circuit, a VBB level higher than a normal level is used. When the self-refresh mode ends, an operation is initiated to lower the VBB level.

The level detector 400 detects when the VBB level gets higher than the first reference voltage VREF1 and enables the first level detecting signal LEV_DET1.

The comparator 450 compares the first driving voltage VDD1 level for driving the pump controller 550 with the second reference voltage VREF2 level and outputs a second level detecting signal LEV_DET2 when the first driving voltage VDD1 level is lower than the second reference voltage VREF2.

The pump controller 550 receives the self-refresh mode signal SREF, the first level detecting signal LEV_DET1, and the second level detecting signal LEV-DET2.

The first signal input circuit 521 of the pump controller 550 detects when the self-refresh mode signal SREF is disabled, and outputs a mode pulse signal MODE_PUL when the self-refresh mode signal SREF is disabled. That is, the first signal input circuit 521 outputs the enabled mode pulse signal MODE_PUL using the inverting and delaying unit 521-1 and the signal combining unit 521-3.

The second signal input circuit 523 receives the second level detecting signal LEV_DET2 and the mode pulse signal MODE_PUL and outputs the clock period control signal CLK_CTRL enabled when any of the second level detecting signal LEV_DET2 and the mode pulse signal MODE_PUL is enabled.

The clock period control signal CLK_CTRL and the level detecting signal LEV_DET1 are input to the clock period controller 530, which adjusts the period of the pump enable signal PUMP_EN, which will be described with reference to FIGS. 7 and 8 illustrating an example of the clock period controller 530.

The clock period control signal CLK_CTRL is input to the first input terminal IN1_NODE of the clock period 530, and the first level detecting signal LEV_DET1 is input to the second input terminal IN2_NODE of the clock period 530.

The first power supply circuit 531 outputs the first driving voltage VDD1 before clock period control signal CLK_CTRL is enabled, but the second power supply circuit 533 supplies the second driving voltage VDD2 higher than the first driving voltage VDD1 to the oscillator 535 when the clock period control signal CLK_CTRL is enabled.

The oscillator 535 is supplied with the second driving voltage VDD2 when the clock period control signal CLK_CTRL is enabled, and begins to generate the pump enable signal PUMP_EN when the first level detecting signal LEV_DET1 from the level detector 400 is enabled.

A periodic signal generating circuit, such as the oscillator 535 generates a periodic signal having a shorter period when the driving voltage is high and a periodic signal having a longer period when the driving voltage is low. In this manner, the period of the pump enable signal PUMP_EN output from the oscillator 535 gets shorter when the second driving voltage VDD2 is input to the oscillator 535 than when the first driving voltage VDD1 is input thereto.

The voltage pump 600 can reduce a falling time of the VBB level to its normal level in response to the pump enable signal PUMP_EN, which is output from the oscillator 535 responsive to the second driving voltage VDD2.

The operation will be described with reference to FIGS. 9 and 10 illustrating another example of the clock period controller 530.

The clock period control signal CLK_CTRL is input to the third input terminal IN3_NODE, and the level detecting signal LEV_DET1 is input to the fourth input terminal IN4_NODE.

The oscillator 532 outputs the pump enable signal PUMP_EN in response to the level detecting signal LEV_DET1 and the pump enable signal PUMP_EN. In response to the clock period control signal CLK_CTRL, the period adjustor 534 outputs the pump enable signal PUMP_EN to the first node A and the second node B.

The period delay circuit 536 delays the pump enable signal PUMP_EN on the second node B.

The period of the pump enable signal PUMP_EN can be adjusted depending on the number of the inverters in the period adjustor 534.

That is, when the clock period control signal CLK_CTRL is enabled, to make the period of the pump enable signal PUMP_EN shorter, the pump enable signal PUMP_EN is generated by the NAND gate ND101 and the two inverting units IV101 and IV102 and output to the first node A, and when the mode pulse signal MODE_PUL is disabled, to make the period of the pump enable signal PUMP_EN longer, the pump enable signal PUMP-EN is generated by the NAND gate ND101 and the four inverting units IV101, IV102, IV105, and IV106.

The voltage pump 600 can reduce a falling time of the VBB level to its normal level in response to the pump enable signal PUMP_EN on the first node A.

It is assumed that the generated internal voltage IN_VT is VPP and the mode signal MODE_SIG is a deep power down mode signal DPD of the semiconductor integrated circuit.

If the semiconductor integrated circuit enters a deep power down mode, an internal power is disabled, thereby reducing a VPP level. An operation for elevating the VPP level is initiated when the deep power down mode ends.

The level detector 400 detects the VPP level lower than the first reference voltage VREF1 and activates the level detecting signal LEV_DET1.

The comparator 450 compares the first driving voltage VDD1 level for driving the pump controller 550 with the second reference voltage VREF2 level and outputs the second level detecting signal LEV_DET2 enabled when the first driving voltage VDD1 level is lower than the second reference voltage VREF2.

The pump controller 550 receives the deep power down mode signal DPD, the first level detecting signal LEV_DET1 and the second level detecting signal LEV_DET2.

In the pump controller 550, the first signal input circuit 521 detects when the deep power down mode signal DPD is disabled, and outputs a mode pulse signal MODE_PUL when the deep power down mode signal DPD is disabled. That is, the first signal input circuit 521 outputs the enabled mode pulse signal MODE_PUL using the inverting and delaying unit 521-1 and the signal combining unit 521-3.

The second signal input circuit 523 receives the second level detecting signal LEV_DET2 and the mode pulse signal MODE_PUL and outputs the clock period control signal CLK_CTRL enabled when one of the second level detecting signal LEV_DET2 and the mode pulse signal MODE_PUL is enabled.

The clock period control signal CLK_CTRL and the level detecting signal LEV_DET1 are input to the clock period controller 530, which adjusts the period of the output pump enable signal PUMP_EN, which will be described with reference to FIGS. 7 and 8 illustrating an example of the clock period controller 530.

The clock period control signal CLK_CTRL is input to the first input terminal IN1_NODE, and the level detecting signal LEV_DET1 is input to the second input terminal IN2_NODE.

The first power supply circuit 531 outputs the first driving voltage VDD1 before the clock period control signal CLK_CTRL is enabled, but the second power supply circuit 533 supplies the second driving voltage VDD2 higher than the first driving voltage VDD1 to the oscillator 535 when clock period control signal CLK_CTRL is enabled.

The oscillator 535 is supplied with the second driving voltage VDD2 when the clock period control signal CLK_CTRL is enabled, and begins to generate the pump enable signal PUMP_EN when the first level detecting signal LEV_DET1 from the level detector 400 is enabled.

A periodic signal generating circuit, such as the oscillator 535 generates a periodic signal having a shorter period when the driving voltage is high and a periodic signal having a longer period when the driving voltage is low. In this manner, the period of the pump enable signal PUMP_EN from the oscillator 535 gets shorter when the second driving voltage VDD2 is input to the oscillator 535 than when the first driving voltage VDD1 is input thereto.

The voltage pump 600 can reduce a rising time of the VPP level to its normal level in response to the pump enable signal PUMP_EN, which is output from the oscillator 535 responsive to the second driving voltage VDD2.

The operation will be described with reference to FIGS. 9 and 10 illustrating another example of the clock period controller 530.

The clock period control signal CLK_CTRL is input to the third input terminal IN3_NODE, and the level detecting signal LEV_DET1 is input to the fourth input terminal IN4_NODE.

The oscillator 532 outputs the pump enable signal PUMP_EN in response to the level detecting signal LEV_DET1 and the pump enable signal PUMP_EN. In response to the clock period control signal CLK_CTRL, the period adjustor 534 outputs the pump enable signal PUMP_EN to the first node A and the second node B. The period delay circuit 536 delays the pump enable signal PUMP_EN on the second node B.

The period of the pump enable signal PUMP_EN can be adjusted depending on the number of the inverters in the period adjustor 534.

That is, when the clock period control signal CLK_CTRL is enabled, to make the period of the pump enable signal PUMP_EN shorter, the pump enable signal PUMP_EN is generated by the NAND gate ND101 and the two inverting units IV101 and IV102 and output to the first node A, and when the clock period control signal CLK_CTRL is disabled, to make the period of the pump enable signal PUMP_EN longer, the pump enable signal PUMP_EN is generated by the NAND gate ND101 and the four inverting units IV101, IV102, IV105, and IV106.

The voltage pump 600 can reduce a rising time of the VPP level to its normal level in response to the pump enable signal PUMP_EN on the first node A.

As described above, in the internal voltage generator for a semiconductor integrated circuit, when the driving voltage from the pump controller is lowered, a high driving voltage is supplied making the period of the pump enable signal PUMP_EN shorter, and when the self-refresh mode and the deep power down mode are exited, a high driving voltage is supplied to the pump controller making the period of the pump enable signal PUMP_EN shorter. Thus, it is possible to shorten a stabilizing time of the internal voltage.

In the described internal voltage generator for a semiconductor integrated circuit, when the driving voltage from the clock generator is lowered or the VBB level and the VPP level are abnormal due to a specific mode signal of the semiconductor integrated circuit, the levels can quickly return to their normal level.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An internal voltage generator for a semiconductor integrated circuit, comprising:
a level detector for comparing an internal voltage with a reference voltage, to output a level detecting signal;
a pump controller for outputting a pump enable signal in response to a mode signal and the level detecting signal; and
a voltage pump for generating the internal voltage in response to the pump enable signal.

2. The internal voltage generator as set forth in claim 1, wherein the mode signal is either a self-refresh mode signal or a deep power down mode signal.

3. The internal voltage generator as set forth in claim 1, wherein the pump controller comprises:
a signal input circuit for generating and outputting a mode pulse signal in response to the mode signal, the mode pulse signal being enabled when the mode signal is disabled; and
a clock period controller for generating the pump enable signal having a period adjusted in response to the mode pulse signal and the level detecting signal.

4. The internal voltage generator as set forth in claim 3, wherein the signal input circuit performs a logical operation on a delayed inverted signal, which is obtained by inverting and delaying the mode signal, and the mode signal to generate the mode pulse signal when the mode signal is disabled.

5. The internal voltage generator as set forth in claim 4, wherein the signal input circuit comprises:
an inverting and delaying unit for outputting the delayed inverted signal; and
a signal combining unit for performing the logical operation, which is a NOR operation, on the mode signal and the delayed inverted signal to output the mode pulse signal.

6. The internal voltage generator as set forth in claim 3, wherein the clock period controller generates the pump enable signal in response to the mode pulse signal, one of two different driving voltages being supplied as a power supply voltage to the clock period controller.

7. The internal voltage generator as set forth in claim 6, wherein the different driving voltages comprise a first driving voltage, and a second driving voltage higher than the first driving voltage.

8. The internal voltage generator as set forth in claim 7, wherein the clock period controller comprises:
a first power supply circuit for supplying the first driving voltage when the mode pulse signal is disabled;
a second power supply circuit for supplying the second driving voltage when the mode pulse signal is enabled; and
an oscillator selectively supplied with either the first driving voltage or the second driving voltage for generating the pump enable signal in response to the level detecting signal and the pump enable signal.

9. The internal voltage generator as set forth in claim 3, wherein the clock period controller comprises:
an oscillator for generating the pump enable signal in response to the level detecting signal and the pump enable signal;
a period adjustor for outputting the pump enable signal from the oscillator to a first node and a second node in response to the mode pulse signal; and
a period delay circuit for delaying the period of the pump enable signal from the oscillator on the second node and outputting the resulting pump enable signal.

10. The internal voltage generator as set forth in claim 9, wherein the pump enable signal comprises a first pump enable signal output via the first node, and a second pump enable signal which is the resulting pump enable signal output via the period delay circuit.

11. The internal voltage generator as set forth in claim 10, wherein the clock period controller determines whether the period adjustor generates the pump enable signal via the oscillator or via both the oscillator and the period delay circuit.

12. The internal voltage generator as set forth in claim 5, wherein the inverting and delaying unit comprises an odd number of inverting units connected in series.

13. The internal voltage generator as set forth in claim 5, wherein the signal combining unit comprises a NOR gate.

14. The internal voltage generator as set forth in claim 8, wherein the first power supply circuit comprises a switching device responsive to the mode pulse signal.

15. The internal voltage generator as set forth in claim 14, wherein the second power supply circuit comprises:
an inverting unit for inverting the mode pulse signal; and
a second switching device coupled to the inverting unit.

16. The internal voltage generator as set forth in claim 15, wherein the switching devices comprise PMOS transistors.

17. The internal voltage generator as set forth in claim 8, wherein the oscillator comprises:
a NAND gate responsive to the level detecting signal and the pump enable signal to produce an output signal; and
an even number of inverting units for subsequently inverting the output signal of the NAND gate.

18. The internal voltage generator as set forth in claim 10, wherein the oscillator comprises:
a NAND gate responsive to the level detecting signal and the pump enable signal to produce an output signal; and
an even number of inverting units for subsequently inverting the output signal of the NAND gate.

19. The internal voltage generator as set forth in claim 10, wherein the period adjustor comprises:
a first transfer gate for outputting the pump enable signal from the oscillator to the first node; and
a second transfer gate for outputting the pump enable signal from the oscillator to the second node.

20. The internal voltage generator as set forth in claim 10, wherein the period delay circuit comprises an even number of inverting units.

21. The internal voltage generator as set forth in claim 19, wherein the first transfer gate is enabled when the mode pulse signal is enabled and the second transfer gate is enabled when the mode pulse signal is disabled.

22. An internal voltage generator for a semiconductor integrated circuit, comprising:
a level detector for comparing an internal voltage with a first reference voltage to output a first level detecting signal;
a comparator for comparing a first driving voltage with a second reference voltage to output a second level detecting signal;
a pump controller for outputting a pump enable signal in response to the first level detecting and the second level detecting signal; and
a voltage pump for generating the internal voltage in response to the pump enable signal.

23. The internal voltage generator as set forth in claim 22, wherein the comparator configured to enable the second level detecting signal enabled when the first driving voltage is lower than the second reference voltage.

24. The internal voltage generator as set forth in claim 22, wherein the pump controller generates the pump enable signal in response to the second level detecting signal, one of two different driving voltages being supplied as a power supply voltage to the pump controller.

25. The internal voltage generator as set forth in claim 24, wherein the different driving voltages comprise the first driving voltage, and the second driving voltage that is higher than the first driving voltage.

26. The internal voltage generator as set forth in claim 25, wherein the pump controller comprises:
a first power supply circuit for supplying the first driving voltage when the second level detecting signal is disabled;
a second power supply circuit for supplying the second driving voltage when the second level detecting signal is enabled; and
an oscillator selectively supplied with either the first driving voltage or the second driving voltage for generating the pump enable signal in response to the first level detecting signal and the pump enable signal fed back to the oscillator.

27. The internal voltage generator as set forth in claim 22, wherein the pump controller comprises:
an oscillator for generating the pump enable signal in response to the first level detecting signal and the pump enable signal fed back to the oscillator;
a period adjustor for outputting the pump enable signal from the oscillator to a first node and a second node in response to the second level detecting signal; and
a period delay circuit for delaying a period of the pump enable signal from the oscillator on the second node and outputting the resulting pump enable signal.

28. The internal voltage generator as set forth in claim 27, wherein the pump enable signal comprises a first pump enable signal output via the first node, and a second pump enable signal which is the resulting pump enable signal output via the period delay circuit.

29. The internal voltage generator as set forth in claim 27, wherein the pump controller determines whether the period adjustor generates the pump enable signal via the oscillator or via both the oscillator and the period delay circuit.

30. The internal voltage generator as set forth in claim 26, wherein the first power supply circuit comprises a switching device responsive to the second level detecting signal.

31. The internal voltage generator as set forth in claim 30, wherein the second power supply circuit comprises:
an inverting unit for inverting the second level detecting signal; and
a second switching device coupled to the inverting unit.

32. The internal voltage generator as set forth in claim 31, wherein the switching devices comprise PMOS transistors.

33. The internal voltage generator as set forth in claim 26, wherein the oscillator comprises:
a NAND gate responsive to the level detecting signal and the pump enable signal to produce an output signal; and
an even number of inverting units for subsequently inverting the output signal of the NAND gate.

34. The internal voltage generator as set forth in claim 28, wherein the oscillator comprises:
a NAND gate responsive to the first level detecting signal and the pump enable signal to produce an output signal; and
an even number of inverting units for subsequently inverting the output signal of the NAND gate.

35. The internal voltage generator as set forth in claim 28, wherein the period adjustor comprises:
a first transfer gate for outputting the pump enable signal from the oscillator to the first node; and
a second transfer gate for outputting the pump enable signal from the oscillator to the second node.

36. The internal voltage generator as set forth in claim 28, wherein the period delay circuit comprises an even number of inverting units.

37. The internal voltage generator as set forth in claim 35, wherein the first transfer gate is enabled when the second level detecting signal is enabled and the second transfer gate is enabled when the second level detecting signal is disabled.

38. An internal voltage generator for a semiconductor integrated circuit, the internal voltage generator comprising:
a level detector for comparing an internal voltage with a first reference voltage to output a first level detecting signal;
a comparator for comparing a first driving voltage with a second reference voltage to output a second level detecting signal;
a pump controller for outputting a pump enable signal in response to a mode signal, the first level detecting signal and the second level detecting signal; and
a voltage pump for generating the internal voltage in response to the pump enable signal.

39. The internal voltage generator as set forth in claim 38, wherein the comparator is configured to enable the second level detecting signal when the first driving voltage is lower than the second reference voltage.

40. The internal voltage generator as set forth in claim 38, wherein the pump controller comprises:
a signal input circuit for outputting a clock period control signal in response to the second level detecting signal and the mode signal; and
a clock period controller for generating the pump enable signal having a period adjusted in response to the clock period control signal and the first level detecting signal.

41. The internal voltage generator as set forth in claim 40, wherein the signal input circuit comprises:
a first signal input circuit for generating a mode pulse signal in response to the mode signal, the mode pulse signal being enabled when the mode signal is disabled; and
a second signal input circuit for outputting the clock period control signal in response to the mode pulse signal and the second level detecting signal.

42. The internal voltage generator as set forth in claim 41, wherein the first signal input circuit performs a logical operation on a delayed inverted signal, which is obtained by inverting and delaying the mode signal, and the mode signal to generate the mode pulse signal when the mode signal is disabled.

43. The internal voltage generator as set forth in claim 42, wherein the first signal input circuit comprises:
an inverting and delaying unit for outputting the delayed inverted signal; and
a signal combining unit for performing the logical operation, which is a NOR operation, on the mode signal and the delayed inverted signal to output the mode pulse signal.

44. The internal voltage generator as set forth in claim 41, wherein the second signal input circuit comprises a logic device for outputting the clock period control signal, the clock period control signal being enabled when any one of the second level detecting signal and the mode pulse signal is enabled.

45. The internal voltage generator as set forth in claim 40, wherein the clock period controller generates the pump enable signal in response to the clock period control signal, one of two different driving voltages being supplied as a power supply voltage to the clock period controller.

46. The internal voltage generator as set forth in claim 45, wherein the different driving voltages comprise a first driving voltage, and a second driving voltage higher than the first driving voltage.

47. The internal voltage generator as set forth in claim 46, wherein the clock period controller comprises:
a first power supply circuit for supplying the first driving voltage when the clock period control signal is disabled;
a second power supply circuit for supplying a second driving voltage when the clock period control signal is enabled; and
an oscillator selectively supplied with either the first driving voltage or the second driving voltage for generating the pump enable signal in response to the first level detecting signal and the pump enable signal fed back to the oscillator.

48. The internal voltage generator as set forth in claim 40, wherein the clock period controller comprises:
an oscillator for generating the pump enable signal in response to the first level detecting signal and the pump enable signal fed back to the oscillator;
a period adjustor for outputting the pump enable signal from the oscillator to a first node and a second node in response to the clock period control signal; and
a period delay circuit for delaying the period of the pump enable signal from the oscillator on the second node and outputting the resulting pump enable signal.

49. The internal voltage generator as set forth in claim 48, wherein the pump enable signal comprises a first pump enable signal output via the first node, and a second pump enable signal which is the resulting pump enable signal output via the period delay circuit.

50. The internal voltage generator as set forth in claim 49, wherein the clock period controller determines whether the period adjustor generates the pump enable signal via the oscillator or via both the oscillator and the period delay circuit.

51. The internal voltage generator as set forth in claim 43, wherein the inverting and delaying unit comprises an odd number of inverting units connected in series.

52. The internal voltage generator as set forth in claim 43, wherein the signal combining unit comprises a NOR gate.

53. The internal voltage generator as set forth in claim 44, wherein the second signal input circuit comprises:
a NOR gate responsive to the second level detecting signal and the mode pulse signal to produce an output signal; and
an inverting unit for inverting the output signal of the NOR gate.

54. The internal voltage generator as set forth in claim 47, wherein the first power supply circuit comprises a switching device responsive to the clock period control signal.

55. The internal voltage generator as set forth in claim 54, wherein the second power supply circuit comprises:
an inverting unit for inverting the clock period control signal; and
a second switching device coupled to the inverting unit.

56. The internal voltage generator as set forth in claim 55, wherein the switching devices comprise PMOS transistors.

57. The internal voltage generator as set forth in claim 47, wherein the oscillator comprises:
a NAND gate responsive to the first level detecting signal and the pump enable signal to produce an output signal; and
an even number of inverting units for subsequently inverting the output signal of the NAND gate.

58. The internal voltage generator as set forth in claim 48, wherein the oscillator comprises:
a NAND gate responsive to the first level detecting signal and the pump enable signal to produce an output signal; and
an even number of inverting units for subsequently inverting the output signal of the NAND gate.

59. The internal voltage generator as set forth in claim 48, wherein the period adjustor comprises:
a first transfer gate for outputting the pump enable signal from the oscillator to the first node; and
a second transfer gate for outputting the pump enable signal from the oscillator to the second node.

60. The internal voltage generator as set forth in claim 48, wherein the period delay circuit comprises an even number of inverting units.

61. The internal voltage generator as set forth in claim 59, wherein the first transfer gate is enabled when the clock period control signal is enabled and the second transfer gate is enabled when the mode pulse signal is disabled.
